(19) United States
(12) Patent Application Publication
(10) Pub. No.: US 2019/0011568 A1
(43) Pub. Date: Jan. 10, 2019

(54) DEVICE FOR COMBINING MULTIPLE SATELLITE NAVIGATION SIGNALS, AND SIGNAL PROCESSING DEVICE COMPRISING SAME

(71) Applicant: Korea Aerospace Research Institute, Daejeon (KR)

(72) Inventors: Sung Hyuck IM, Daejeon (KR); Moon Beom HEO, Daejeon (KR); Eun Seong SON, Daejeon (KR); Koon Tack KIM, Daejeon (KR)

(21) Appl. No.: 16/065,822

(22) PCT Filed: Dec. 21, 2016
(86) PCT No.: PCT/KR2016/015016

§ 371 Date: Jun. 25, 2018

(30) Foreign Application Priority Data
Dec. 24, 2015 (KR) 10-2015-0186202

(51) Int. Cl. G01S 19/25; G01S 19/36

(52) U.S. Cl. CPC G01S 19/256; G01S 19/36

(57) ABSTRACT

Disclosed are a multiple satellite navigation signal combining device, and a signal processing device comprising same. The multiple satellite navigation signal combining device comprises: a plurality of reception antennas for receiving satellite navigation signals from a satellite; a time delay unit for setting one satellite navigation signal, among the satellite navigation signals received by means of the reception antennas, as a reference satellite navigation signal and time-delaying other satellite navigation signals excluding the reference satellite navigation signal; and a signal combining device for combining the reference satellite navigation signal and other satellite navigation signals that have been time-delayed and transmitting same to a global navigation satellite system receiver.

### TECHNICAL FIELD

The present invention relates to a multiple satellite navigation signal combining device and a signal processing device including the same.

### BACKGROUND ART

Since a Global Positioning System (GPS) signal received on the ground has low power of about −160 dBW, the GPS signal is easily affected by diffraction and disruption of a radio wave due to obstacles. Accordingly, studies for reducing a positioning error due to the diffraction and disruption of the GPS signal are actively being carried out.

To reduce the influence of the diffraction and disruption of the GPS signal, methods are used in which GPS signals received by a plurality of reception antennas are collected using a plurality of digital sampling devices and combined.

To use the methods described above, the digital sampling devices configured to digitize the GPS signals received by the plurality of reception antennas need to correspond to the reception antennas, respectively, and time synchronization between the digital sampling devices has to be perfectly performed.

Using the plurality of digital sampling devices has a problem in that an amount of processes increases because an additional time synchronization and an additional compensation process are needed and the number of digitized samples is increased to that of the reception antennas.

### DISCLOSURE

### Technical Problem

The present invention is directed to providing a multiple satellite navigation signal combining device capable of processing satellite navigation signals of multiple antennas received from a plurality of satellites without installing a separate time synchronization device or digitization device and a signal processing device including the same.

### Technical Solution

One aspect of the present invention provides a multiple satellite navigation signal combining device including a plurality of reception antennas configured to receive satellite navigation signals from satellites, a time delay unit configured to set one satellite navigation signal among satellite navigation signals received by the reception antennas as a reference satellite navigation signal and delay the other satellite navigation signals excluding the reference satellite navigation signal and a signal combining unit configured to combine the reference satellite navigation signal and the other delayed satellite navigation signals and transmit the combined signal to a satellite navigation receiver.

The time delay unit may delay the other satellite navigation signals according to a following equation, Equation 1.

s′(t)=S(t+(k−1)d) Equation 1

In Equation 1, s′(t) denotes a delayed satellite navigation signal, s(t) denotes a satellite navigation signal received by the reception antenna, k denotes a satellite navigation signal number, and d denotes a delay constant.

The delay constant may be determined according to a length of a chip code.

Another aspect of the present invention provides a multiple satellite navigation signal processing device including a combining device having a plurality of reception antennas configured to receive satellite navigation signals from satellites, a time delay unit configured to set one satellite navigation signal among the satellite navigation signals received by the reception antennas as a reference satellite navigation signal and delay the other satellite navigation signals except the reference satellite navigation signal, and a signal combining unit configured to combine the reference satellite navigation signal and the other delayed satellite navigation signals and transmit the combined signal to a satellite navigation receiver, and the satellite navigation receiver having a correlator configured to process the combined signal by correlating the combined signal with the satellites, and an arithmetic calculator configured to calculate navigation information using the correlated signal.

### Advantageous Effects

A multiple satellite navigation signal combining device and a signal processing device including the same according to the present invention can process satellite navigation signals of multiple antennas received from a plurality of satellites without installing a separate time synchronization device or digitization device.

### DESCRIPTION OF DRAWINGS

FIG. 1 is a conceptual view illustrating a multiple satellite navigation signal combining device according to one embodiment of the present invention.

FIG. 2 is a conceptual view illustrating a multiple satellite navigation signal processing device according to one embodiment of the present invention.

FIG. 3 is a configuration block diagram illustrating the multiple satellite navigation signal combining device according to one embodiment of the present invention.

FIG. 4 is a configuration block diagram illustrating the multiple satellite navigation signal processing device according to one embodiment of the present invention.

### MODES OF THE INVENTION

As the invention allows for various changes and numerous embodiments, particular embodiments will be illustrated in the drawings and described in detail in the written description. However, this is not intended to limit the present invention to particular modes of practice, and it is to be appreciated that all changes, equivalents, and substitutes that do not depart from the spirit and technical scope of the present invention are encompassed in the present invention.

It will be understood that, although the terms “first,” “second,” etc. may be used herein to describe various elements, these elements should not be limited by these terms. These terms are only used to distinguish one element from another. For example, a first element could be termed a second element, and a second element could similarly be termed a first element without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements.

The terminology used herein is for the purpose of describing particular embodiments only and is not intended to be limiting to the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, components, and/or groups thereof but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined here.

Example embodiments of the invention will be described below in more detail with reference to the accompanying drawings. Those components that are the same or are corresponding are rendered the same reference numeral regardless of the figure number, and redundant explanations are omitted.

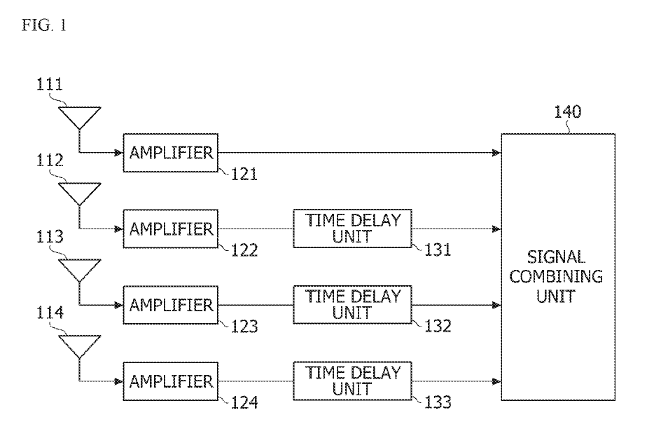

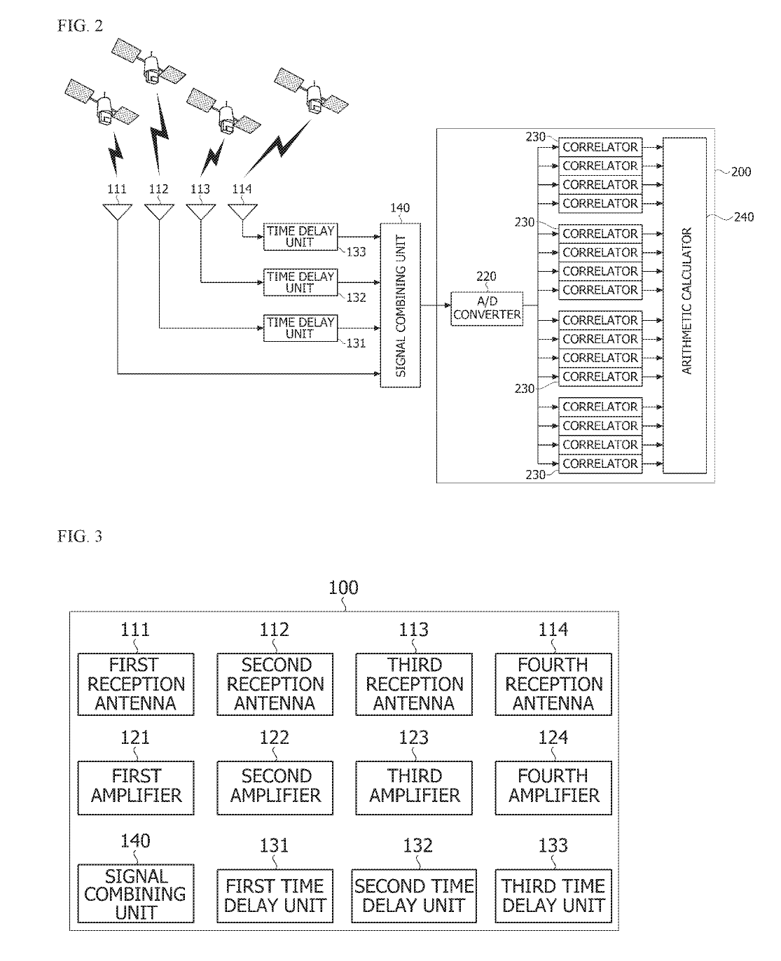

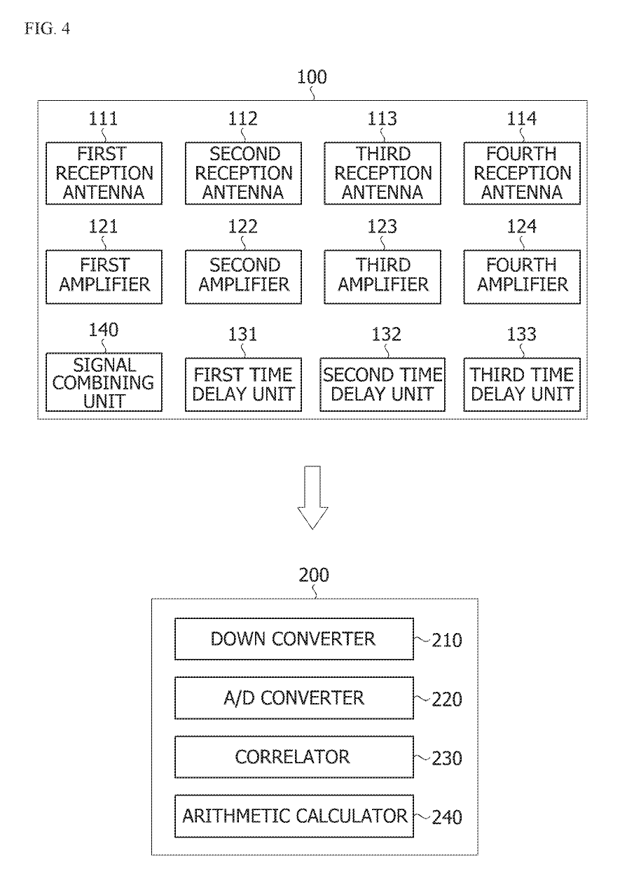

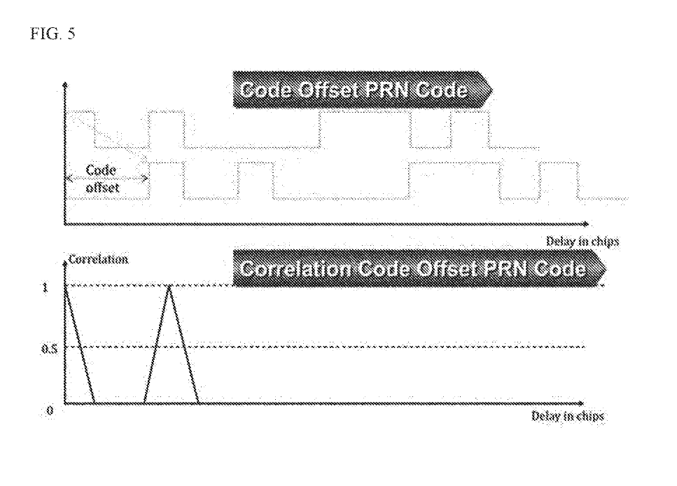

FIG. 1 is a conceptual view illustrating a multiple satellite navigation signal combining device according to one embodiment of the present invention, FIG. 2 is a conceptual view illustrating a multiple satellite navigation signal processing device according to one embodiment of the present invention, FIG. 3 is a configuration block diagram illustrating the multiple satellite navigation signal combining device according to one embodiment of the present invention, and FIG. 4 is a configuration block diagram illustrating the multiple satellite navigation signal processing device according to one embodiment of the present invention.

Referring to FIGS. 1 to 4, the multiple satellite navigation signal processing device according to one embodiment of the present invention may include a combining device 100 having reception antennas 111 to 114, amplifiers 121 to 124, time delay units 131 to 133, and a signal combining unit 140 and a satellite navigation receiver 200 having a down converter 210, an analog-digital (A/D) converter 220, a correlator 230, and an arithmetic calculator 240.

First, the reception antennas 111 to 114 of the combining device 100 may include a plurality of antennas configured to receive satellite navigation signals from satellites. The reception antennas 111 to 114 may include four Global Positioning System (GPS) antennas spaced a predetermined distance from each other and having a visible zone including all zones within an azimuth angle ranging from 0° to +360° and an elevation angle ranging from −90° to +90°.

The amplifiers 121 to 124 may include a first amplifier 121, a second amplifier 122, a third amplifier 123, and a fourth amplifier 124. The amplifiers 121 to 124 may amplify signals received by the reception antennas 111 to 114 and transmit the amplified signals to the time delay units 131 to 133. For example, the amplifiers 121 to 124 may include low noise amplifiers (LNAs) and amplify satellite navigation signals received by the reception antennas 111 to 114.

The time delay units 131 to 133 may include a first time delay unit 131, a second time delay unit 132, and a third time delay unit 133. The time delay units 131 to 133 may set one satellite navigation signal among satellite navigation signals received by the reception antennas 111 to 114 as a reference satellite navigation signal and delay the other satellite navigation signals excluding the reference satellite navigation signal.

An example of the embodiment of the present invention in which the time delay units 131 to 133 set one satellite navigation signal received by the first reception antennas 111 among satellite navigation signals received by the four reception antennas 111 to 114 as the reference satellite navigation signal will be described.

The time delay unit may delay the other satellite navigation signals according to a following equation, Equation 1.

s′(t)=S(t+(k−1)d) Equation 1

In Equation 1, s′(t) may denote a delayed satellite navigation signal, s(t) may denote a satellite navigation signal received by the reception antenna, k may denote a satellite navigation signal number, and d may denote a delay constant.

The reference satellite navigation signal is transmitted to the signal combining unit 140 in a state in which the reference satellite navigation signal is not delayed, and the time delay units 131 to 133 delay the remaining satellite navigation signals according to Equation 1. That is, the first time delay unit 131 delays a second satellite navigation signal received by the second reception antennas 112 by d, the second time delay unit 132 delays a third satellite navigation signal received by the third reception antennas 113 by 2d, and the third time delay unit 133 delays a fourth satellite navigation signal received by the fourth reception antennas 114 by 3d.

In the drawings, Code Offset denotes a delay, a GPS signal is a direct sequence spread spectrum (DSSS) signal, and when the GPS signal is delayed by one chip or more, a correlation does not occur. Therefore, when an original signal is combined with a signal delayed by two chips or more and the correlator performs a correlation as illustrated in an upper graph of the drawing, correlation results are derived at a starting point of the original signal and a starting point of the delayed signal, a mutual influence between the original signal and the delayed signal is almost zero, and a noise level slightly increases.

In Equation 1, the delay constant d may be determined according to a length of a chip code. A satellite navigation signal is a DSSS signal, and a bit is modulated into a plurality of bits in a chip type and transmitted to the reception antenna in a state in which the bit is spread within a used frequency range. That is, a satellite navigation signal has correlation characteristics in time, and mutual interference does not occur between signals delayed by the length of the chip code or more.

Referring to FIG. 5, Code Offset denotes a time delay, a satellite navigation signal is a DSSS signal, and when the satellite navigation signal is delayed one chip or more, a correlation does not occur. Accordingly, when an original signal is combined with a signal delayed by two chips or more and the correlator performs a correlation as illustrated in the upper graph of FIG. 5, correlation results are derived at a starting point of the original signal and a starting point of the delayed signal as illustrated in a lower graph of FIG. 5, a mutual influence between the original signal and the delayed signal is almost zero, and a noise level slightly increases.

Accordingly, a delay constant d may be determined according to a length of a chip code, for example, the delay constant d may be determined as a multiple of the length of the chip code. For example, when a length of the chip code is 1 μs, and a delay constant d is two times the length of the chip code by delaying two times the length of the chip code to remove a mutual interference, the first time delay unit 131 delays a second satellite navigation signal received by the second reception antennas 112 by 2 μs, the second time delay unit 132 delays a third satellite navigation signal received by the third reception antennas 113 by 4 μs, and the third time delay unit 133 delays a fourth satellite navigation signal received by the fourth reception antennas 114 by 6 μs.

The signal combining unit 140 may combine the reference satellite navigation signal and the other delayed satellite navigation signals to transmit the combined signal to the satellite navigation receiver 200. The signal combining unit 140 may have broadband frequency characteristics capable of covering all bandwidths of satellite navigation signals and may be a radio frequency (RF) signal combining device configured to receive a plurality of satellite navigation signals, combine the plurality of satellite navigation signals into one signal, and output the combined signal.

Next, the down converter 210 of the satellite navigation receiver 200 may convert a combined signal received from the signal combining unit 140 into a baseband signal. For example, the down converter 210 multiplies a combined signal by a carrier frequency to convert the combined signal into a baseband signal.

The A/D converter 220 may sample a combined signal which is an RF signal to convert the combined signal into a digital signal.

The correlator 230 may correlate a combined signal with satellites and process the combined signal. According to a method of correlating non-combined signals, the correlator 230 may correlate constant delayed signals of the reception antennas with a delayed value of a satellite navigation signal received by the first reception antenna and added according to fixed delay times to calculate a correlation result. That is, the correlator 230 according to one embodiment of the present invention may obtain a correlation result related to delayed satellite navigation signals of the antennas by correlating a signal, which is received by the second reception antenna and to which a delay of 2 μs is added, a signal which is received by the third reception antenna and to which a delay of 4 μs is added, and a signal which is received by the fourth reception antenna and to which a delay of 6 μs is added.

The arithmetic calculator 240 may calculate navigation information using a correlated signal. For example, the arithmetic calculator 240 may calculate navigation information such as a position, speed, and a time by removing an amount of delay (constant), which is due to the time delay unit, from an amount of measured delay including delay times between the satellites and the reception antennas and delay times due to the time delay units, and calculate a control signal for generating a satellite tracking loop.

The terms, such as ‘˜ unit’, used in the present embodiment refer to software, or a hardware component, such as a field-programmable gate array (FPGA) or an application specific integrated circuit (ASIC), and the terms ‘˜ unit’ play certain roles. However, the terms ‘˜ unit’ are not limited to software or hardware. The terms ‘˜ unit’ may be configured to be placed in an addressing storage medium or to reproduce one or more processors. Thus, in an example, the terms ‘˜ unit’ include components, such as software components, object-oriented software components, class components, task components, processes, functions, properties, procedures, subroutines, segments of a program code, drivers, firmware, micro-codes, circuits, data, a database, data structures, tables, arrays, and variables. Functions provided by these components and the terms ‘˜ unit’ may be combined with a smaller number of components and ‘˜ units’ or may be subdivided into additional components and ‘˜ units’. Furthermore, the components and ‘˜ units’ may also be implemented to reproduce one or more central processing units (CPUs) within a device or a security multimedia card.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A multiple satellite navigation signal combining device comprising:
a plurality of reception antennas configured to receive satellite navigation signals from satellites;
a time delay unit configured to set one satellite navigation signal among satellite navigation signals received by the reception antennas as a reference satellite navigation signal and delay the other satellite navigation signals excluding the reference satellite navigation signal; and
a signal combining unit configured to combine the reference satellite navigation signal and the other delayed satellite navigation signals and transmit the combined signal to a satellite navigation receiver.

2. The multiple satellite navigation signal combining device of claim 1, wherein the time delay unit delays the other satellite navigation signals according to a following equation, Equation 1.
s′(t)=S(t+(k−1)d) Equation 1
In Equation 1, s′(t) denotes a delayed satellite navigation signal, s(t) denotes a satellite navigation signal received by the reception antenna, k denotes a satellite navigation signal number, and d denotes a delay constant.

3. The multiple satellite navigation signal combining device of claim 2, wherein the delay constant is determined according to a length of a chip code.

4. A multiple satellite navigation signal processing device comprising:
a combining device including a plurality of reception antennas configured to receive satellite navigation signals from satellites, a time delay unit configured to set one satellite navigation signal among the satellite navigation signals received by the reception antennas as a reference satellite navigation signal and delay the other satellite navigation signals excluding the reference satellite navigation signal, and a signal combining unit configured to combine the reference satellite navigation signal and the other delayed satellite navigation signals and transmit the combined signal to a satellite navigation receiver; and
the satellite navigation receiver, which includes a correlator configured to process the combined signal by correlating the combined signal with the satellites, and an arithmetic calculator configured to calculate navigation information using the correlated signal.

5. The multiple satellite navigation signal processing device of claim 4,
wherein the time delay unit delays the other satellite navigation signals according to a following equation, Equation 2.
s′(t)=S(t+(k−1)d) Equation 2
In the Equation 2, s′(t) denotes a delayed satellite navigation signal, s(t) denotes a satellite navigation signal received by the reception antenna, k denotes a satellite navigation signal number, and d denotes a delay constant.

6. The multiple satellite navigation signal processing device of claim 5, wherein
the delay constant is determined according to a length of a chip code.
